(19) United States
(12) Patent Application Publication
(10) Pub. No.: US 2022/0380121 A1
(43) Pub. Date: Dec. 1, 2022

(54) AUTONOMOUS ROBOTIC WASTE COLLECTION SYSTEM

(71) Applicant: Lidbot Inc., Walnut, CA (US)

(72) Inventor: Hamoun Haji Kar MAHABADI, Toronto (CA)

(21) Appl. No.: 17/724,020

(22) Filed: Apr. 19, 2022

Related U.S. Application Data
(60) Provisional application No. 63/193,340, filed on May 26, 2021.

(51) Int. Cl. B65F 1/12; B65F 1/14; B65F 3/04

(52) U.S. Cl. CPC B65F 1/12; B65F 1/1452; B65F 1/1473; B65F 3/041; B65F 2210/1443; B65F 2210/128; B65F 2210/168

(57) ABSTRACT

Systems and methods for autonomous robotic waste and recycling bin collection, including a plurality of receptacles, having a lid, a fill sensor on the underside of the lid and a collection bin, with a robot engagement mechanism. The fill sensor detects a fill level of the receptacle. The system also has autonomous robots, having a plurality of robot sensors and at least one prong connected to a motor. A bin collection server receives the fill levels from the fill sensors; determines a plurality of full bins; generates a collection instruction and sends the collection instruction to an autonomous robot. The autonomous robot navigates to each bin; inserts at least one prong into the robot engagement mechanism; lifts the collection bin; navigates to the collection facility; and deposits the collection bin in the collection facility.

### CROSS-REFERENCE

This application claims the benefit of U.S. Provisional Patent Application No. 63/193,340 filed May 26, 2021 entitled AUTONOMOUS ROBOTIC WASTE COLLECTION SYSTEM, the entire contents of which are herein incorporated by reference into the Detailed Description herein below.

### TECHNICAL FIELD

Example embodiments relate to robotics for waste monitoring and collection.

### BACKGROUND

Waste management is a fundamental component of buildings and complexes that allow people to occupy without the inconvenience and discomfort that can be caused by inadequate waste management. Costs for waste management of buildings or complexes can be high. There is also substantial seasonal variation for the requirements of a waste management system and currently there is limited ability to obtain site-specific data related waste management system.

Commercial buildings in particular have substantial waste and recycling management requirements and there is a need to provide a system that can lower costs of waste and recycling collection, increase the cleanliness of a building overall and provide site-specific data and information on waste and recycling production and collection, for example at a lower cost.

### SUMMARY

Example embodiments relate to systems and methods for autonomous and robotic waste and recycling collection within a premises. Example embodiments relate to systems for optimizing waste and recycling collection in buildings, including monitoring fill levels of individual waste and recycling bins, mapping the premises, generating routes for autonomous waste and recycling collection.

An example embodiment is a system having several smart bins with a fill sensor, several autonomous robots, a server and a collection facility. Example embodiments of the system include the server receiving information about the fill levels of each smart bin from the fill sensors and generating collection instructions to be sent to the autonomous. The collection instructions can include the specific smart bins to empty, the route to take when emptying the bins and any other relevant information, such as the type of waste (e.g. paper recycling). The server can send the instruction to the autonomous robots which can then navigate to the smart bins to be emptied. The autonomous robot can then insert prongs into openings in the smart bins and lift a collection bin out of the smart bin, or use other engagement mechanisms, such as a gripping arm to grasp and lift the collection bin. The autonomous robot can then take the collection bin to the collection facility of the premises (often located in the basement) and deposit the bin to be emptied into waste containers in the collection facility. The autonomous robots can then retrieve empty collection bins from the collection facility and replace the empty bins into the smart bins.

An advantage of this embodiment is an entirely automated system for waste management. The system is able to collect and remove waste throughout buildings with little to no involvement from the owner of the building.

Another advantage of the system is that the information received from the fill sensors and the autonomous robots is stored in the server and the server can provide an interface for a user to monitor the system and provide instructions or modifications to schedule and routes. The server can also analyze waste collection and management within the building by providing total volumes of waste produced and collected, temperatures of the smart bins, etc.

Another advantage of the system is a camera or several cameras located in the collection facility that monitor the waste containers. When the waste containers are full or reach a threshold fill level, server can receive that information from the cameras and can notify a user to call the local waste removal company, or can automatically dispatch the local waste removal company to come to the premises and remove the waste.

Another advantage is that real-time, dynamic scheduling and routing of both staff and autonomous robots allow for more efficient and accurate waste collection throughout a premises. By using machine learning, the system can improve the scheduling and routing over time and can be able to predict and track waste production on a premises.

In another example, the autonomous robot lifts the collection bin and collects the waste and/or recycling from the collection bin, and carries the waste and/or recycling to the collection facility.

An example embodiment is a system for autonomous waste collection, the system comprising: a plurality of receptacles, each receptacle having a lid, a fill sensor, and a collection bin, the collection bin having a robot engagement mechanism, the fill sensor being located on an underside of the lid, wherein the fill sensor is configured to detect a fill level of the receptacle; at least one autonomous robot, the at least one autonomous robot having a plurality of robot sensors and a bin engagement mechanism; a bin collection server, wherein the bin collection server is separate from the plurality of receptacles and is configured to: receive a respective fill level from each of the fill sensors; determine that at least one collection bin has a respective fill level that exceeds a threshold; generate a collection instruction for the at least one collection bin that exceeds the threshold; send the collection instruction to the at least one autonomous robot; wherein the at least one autonomous robot is configured to: receive the collection instruction from the bin collection server; navigate, using the plurality of robot sensors, to the at least one collection bin that exceeds the threshold; engage the bin engagement mechanism with a respective robot engagement mechanism of the collection bin that exceeds the threshold; collect waste from the collection bin that exceeds the threshold; navigate, using the plurality of robot sensors, to a collection facility while carrying the waste; and deposit the waste in the collection facility.

In an example embodiment of any of the above, the autonomous robot is further configured to collect the waste by lifting, using the bin engagement mechanism, the respective collection bin; carry the respective collection bin while navigating to the collection facility; and deposit the waste by depositing the respective collection bin in the collection facility.

In an example embodiment of any of the above, the autonomous robot has a robot waste bin, the autonomous robot being further configured to: collect the waste by lifting, using the bin engagement mechanism, the respective collection bin; deposit the waste into the robot waste bin; carry the robot waste bin while navigating to the collection facility; and deposit the waste by emptying the robot waste bin in a waste container located in the collection facility.

In an example embodiment of any of the above, the bin collection server is further configured to: identify at least one of a plurality of empty receptacles; generate a replacement instruction for each of the at least one of the plurality of empty receptacles; send the replacement instruction to the autonomous robot; wherein the collection facility has a plurality of empty collection bins; wherein the autonomous robot is further configured to: navigate, using the plurality of robot sensors, to the collection facility; engage the bin engagement mechanism with the robot engagement mechanism of at least one of the plurality of empty collection bins; lift, using the bin engagement mechanism, the at least one of the plurality of empty collection bins; navigate, using the plurality of robot sensors, to the at least one of the plurality of empty receptacles; and insert an empty collection bin into each of the at least one of the plurality of empty receptacles.

In an example embodiment of any of the above, the bin collection server includes a machine learning model.

In an example embodiment of any of the above, the plurality of robot sensors include a proximity sensor, a visual sensor, or an accelerometer.

In an example embodiment of any of the above, the autonomous robot has a scale.

In an example embodiment of any of the above, the autonomous robot is configured to detect a mass of a robot load using the scale.

In an example embodiment of any of the above, the fill sensor is an infra-red distance sensor.

In an example embodiment of any of the above, each fill sensor detects the fill level of the corresponding receptacle by measuring a distance from a top of an interior of the collection bin to a bottom of the interior of the collection bin.

In an example embodiment of any of the above, each of the fill sensors is connected to a power source and is configured to remain disconnected from the power source; the bin collection server is further configured to: send a wake up notification to each of the fill sensors; and each of the fill sensors is further configured to: receive the wake up notification; connect to the power source; detect the fill level of each of the plurality of receptacles; and send the fill level to the bin collection server.

In an example embodiment of any of the above, the bin collection server is configured to send the wake up notification based on a pre-determined schedule.

In an example embodiment of any of the above, the power source includes a battery; and the fill sensor is configured to send a battery level to the bin collection server.

In an example embodiment of any of the above, each receptacle has a power source that can provide power to the receptacle and the fill sensor.

In an example embodiment of any of the above, the power source is a solar power source.

In an example embodiment of any of the above, the collection bin includes a top cover that is configured to sealingly engage with the top of the collection bin.

In an example embodiment of any of the above, the system further comprises a docking station corresponding to the at least one autonomous robot; the bin collection server being further configured to: generate a docking instruction; the autonomous robot being further configured to: receive, from the bin collection sever, the docking instruction; and navigate and move, using the plurality of robot sensors, to the docking station.

In an example embodiment of any of the above, the bin collection server is further configured generate the docking instruction after receiving, from the at least one autonomous robot, a power status of the at least one autonomous robot.

In an example embodiment of any of the above, the bin collection server is further configured to convert the fill level to a fill percentage.

In an example embodiment of any of the above, the fill sensor is further configured to detect a temperature of each receptacle.

In an example embodiment of any of the above, the fill sensor is integrated into the lid.

In an example embodiment of any of the above, the fill sensor is an individual component, the fill sensor being configured to attached to the lid.

The system of claim 1, wherein the robot engagement mechanism comprises at least one opening in a bottom of an exterior of the collectible bin; wherein the bin engagement mechanism includes at least one prong connected to a motor, the at least one opening configured to receive the at least one prong; and wherein when the robot engagement mechanism has received the at least one prong, the motor is configured to lift the collection bin; and wherein the collection bin is configured to move with the autonomous robot when the autonomous robot moves.

In an example embodiment of any of the above, the robot engagement mechanism further comprises a mechanical clasp; and wherein when the at least one prong is inserted into the at least one opening, the mechanical clasp is configured to grasp the at least one prong.

In an example embodiment of any of the above, the robot engagement mechanism further comprises a magnet; and wherein when the at least one prong is inserted into the at least one opening, the robot engagement mechanism magnetically connects to the at least one prong.

In an example embodiment of any of the above, the bin engagement mechanism is a gripping arm with at least two fingers; and wherein the bin engagement mechanism engages the robot engagement mechanism by: positioning the at least two fingers on opposing sides of the collection bin; and closing the gripping arm by moving the at least two fingers towards the collection bin.

In an example embodiment of any of the above, the at least one autonomous robot is a humanoid robot; the bin engagement mechanism includes a robot arm on opposing sides of the humanoid robot; wherein the bin engagement mechanism engages the robot engagement mechanism by: positioning the robot arms on opposing sides of the collection bin; and grasping the collection bin by moving the robot arms towards the collection bin.

In an example embodiment of any of the above, the bin collection server is further configured to receive the fill level of each of the plurality of receptacles at pre-determined intervals.

In an example embodiment of any of the above, the bin collection server is configured to determine the pre-determined intervals using a machine learning model.

In an example embodiment of any of the above, the plurality of receptacles, the at least one autonomous robot, and the collection facility are located on a premises.

In an example embodiment of any of the above, the bin collection server is further configured to: generate a map of the premises, the map including a location of each of the plurality of receptacles, the fill level of each of the plurality of receptacles, and a location of the at least one autonomous robot; receive, from the fill sensor and the plurality of robot sensors, a location update for the plurality of receptacles and the autonomous robot; receive, from each of the fill sensors, a new fill level; and update the map of the premises based on the location update.

In an example embodiment of any of the above, the bin collection server further comprises a route management module.

In an example embodiment of any of the above, the route management module is configured to: receive, from the bin collection server, a schedule of staff; and generate, based on the map of the premises and the schedule of staff, a route plan.

In an example embodiment of any of the above, the route management module is configured to: receive, from the bin collection server: the location of the at least one autonomous robot, the location of the plurality of receptacles which exceed the threshold, and the collection instruction; generate, based on the location of the at least one autonomous robot, the location of the plurality of receptacles which exceed the threshold, and the collection instruction, a collection route for the at least one autonomous robot; the autonomous robot being further configured to: receive the collection route from the bin collection server; and navigate and move, using the plurality of robot sensors, along the collection route.

In an example embodiment of any of the above, the route management module is a machine learning model.

In an example embodiment of any of the above, the system further comprises: at least one waste container located in the collection facility; a visual sensor, located in the collection facility; wherein the visual sensor is configured to: detect a fill level of the at least one waste container; the bin collection server being further configured to: receive, from the visual sensor; the fill level of the at least one waste container; and determine, based on the fill level of the at least one waste container, a collection status of the at least one waste container.

In an example embodiment of any of the above, the bin collection server is further configured to: determine, based on the collection status, a waste collection company corresponding to the at least one waste container; and contact the waste collection company.

Another example embodiment is a method for autonomously managing a waste collection system, the method comprising: detecting a fill level of each of a plurality of receptacles, using a fill sensor located on an underside of a lid of each of the plurality of receptacles, wherein each of the plurality of receptacles has a collection bin and a robot engagement mechanism; receiving, by a bin collection server, the fill level of each of a plurality of receptacles; determining, by the bin collection server, that at least one of the plurality of receptacles has a respective fill level that exceeds a threshold; identifying, based on the at least one of the plurality of receptacles has a respective fill level that exceeds a threshold, at least one collection bin which exceeds the threshold; generating, by the bin collection server, a collection instruction for the at least one collection bin which exceeds the threshold; sending, by the bin collection server, the collection instruction to at least one autonomous robot, wherein the at least one autonomous robot has a plurality of robot sensors, a motor and a bin engagement mechanism; receiving, by the at least one autonomous robot, the collection instruction from the bin collection server; determining, by the at least one autonomous robot, a collection path based on the collection instruction; navigating the at least one autonomous robot along the collection path to the at least one collection bin which exceeds the threshold, using the plurality of robot sensors; engaging the bin engagement mechanism with a robot engagement mechanism of the at least one collection bin which exceeds the threshold; collecting waste from the collection bin which exceeds the threshold; determining, by the at least one autonomous robot, an emptying path based on the collection instruction; navigating the at least one autonomous robot along the emptying path, to a collection facility, using the plurality of robot sensors; and depositing the waste in the collection facility.

### BRIEF DESCRIPTION OF THE DRAWINGS

Reference will now be made, by way of example, to the accompanying drawings which show example embodiments, and in which:

FIG. 1 shows a schematic diagram of the autonomous robotic waste and recycling collection system;

FIG. 2A shows an isometric view of an example embodiment of the autonomous robot and waste receptacle;

FIG. 2B shows a top view of the example embodiment of the autonomous robot and waste receptacle in FIG. 2A;

FIG. 2C shows a front view of the example embodiment of the waste receptacle in FIG. 2A;

FIG. 2D shows a side view of the example embodiment of the autonomous robot and waste receptacle in FIG. 2A;

FIG. 3A shows an isometric view of an example embodiment of the autonomous robot and waste receptacle;

FIG. 3B shows a top view of the example embodiment of the waste receptacle in FIG. 3A;

FIG. 3C shows a front view of the example embodiment of the waste receptacle in FIG. 3A;

FIG. 3D shows a side view of the example embodiment of the autonomous robot and waste receptacle in FIG. 3A;

FIG. 4A shows an isometric view of an example embodiment of the autonomous robot and waste receptacle;

FIG. 4B shows a top view of the example embodiment of the waste receptacle in FIG. 4A;

FIG. 4C shows a front view of the example embodiment of the waste receptacle in FIG. 4A;

FIG. 4D shows a side view of the example embodiment of the autonomous robot and waste receptacle in FIG. 4A;

FIG. 5A shows a top view of an example embodiment of the autonomous robot and waste receptacle;

FIG. 5B shows a front view of the example embodiment of the waste receptacle in FIG. 5A;

FIG. 5C shows an isometric view of the example embodiment of the waste receptacle in FIG. 5A;

FIG. 5D shows a side view of the example embodiment of the autonomous robot and waste receptacle in FIG. 5A;

FIG. 6A shows a top view of an example embodiment of the autonomous robot and waste receptacle;

FIG. 6B shows an isometric view of the example embodiment of the waste receptacle in FIG. 6A;

FIG. 6C shows a front view of the example embodiment of the waste receptacle in FIG. 6A;

FIG. 6D shows a side view of the example embodiment of the autonomous robot and waste receptacle in FIG. 6A;

FIG. 7A shows an isometric view of an example embodiment of the autonomous robot and waste receptacle;

FIG. 7B shows a top view of the example embodiment of the waste receptacle in FIG. 7A;

FIG. 7C shows a front view of the example embodiment of the waste receptacle in FIG. 7A;

FIG. 7D shows a side view of the example embodiment of the autonomous robot and waste receptacle in FIG. 7A;

FIG. 8 shows a schematic diagram of an exemplary autonomous robot;

FIG. 9 shows a flow diagram of a method for autonomous robotic waste collection;

Similar reference numerals may have been used in different figures to denote similar components.

### DETAILED DESCRIPTION

Example embodiments relate to robotics for waste collection and management within a premises. Example embodiments relate to systems for optimizing waste and recycling collection in buildings, including monitoring fill levels of individual waste and recycling bins, mapping the premises, generating routes for autonomous waste and recycling collection.

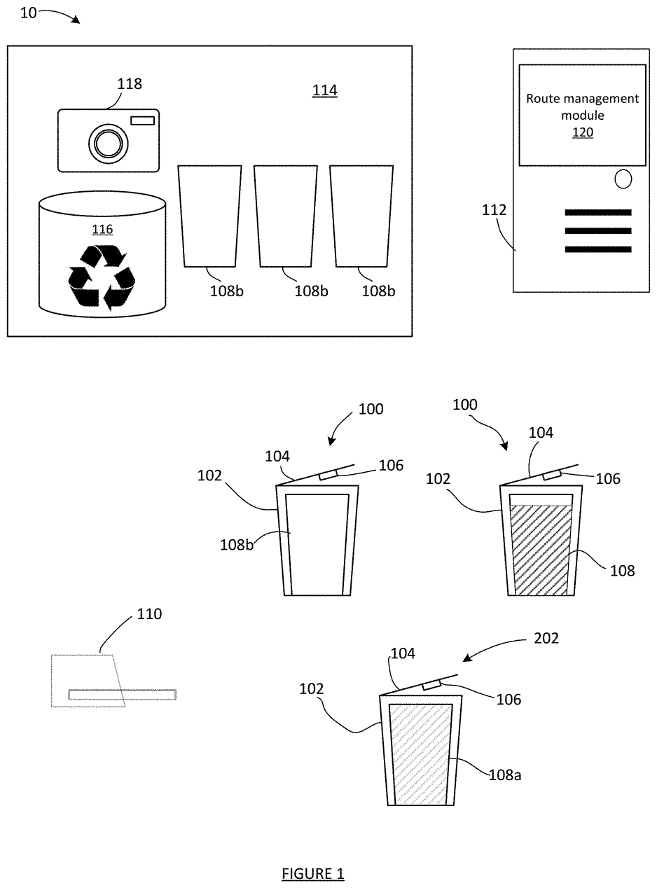

FIG. 1 illustrates a system 10 for the autonomous robotic collection of waste and recycling in a premises. The system includes a number of smart bins 100, a number of autonomous robots 110, a bin collection server 112, and a collection facility 114. While the configuration depicted in FIG. 1 illustrates one autonomous robot 110 and three smart bins 100, the system 10 can include any number of autonomous robots 110 and smart bins 100.

Examples of the smart bins 100 can include a waste receptacle 102, a lid 104, a fill sensor 106, and a collection bin 108. In some examples, the fill sensor 106 is integrated into the lid 104 such that the lid 104 and fill sensor 106 comprise a single component. In another example, the fill sensor 106 is separate from the lid 104 and can be attached to the lid 104 by various fastening means, such as adhesives. In other examples, the lid 104 and the waste receptacle 102 are integrated together.

The smart bins 100 can include a collection bin 108, such that the autonomous robot 110, when collecting waste from a particular smart bin 100, can retrieve the collection bin 108, leaving the waste receptacle 102, lid 104 and fill sensor 106 in place. In the example configuration of FIG. 1, the collection bin 108a shows a smart bin 100 where the fill sensor 106 would detect a 100% fill level and the collection bin 108b show an empty collection bin 108. In some examples, the collection bins 108 can include a top cover, which allows the collection bin 108 to be sealed when the collection bin 108 is removed from the waste receptacle 102 to ensure that the waste remains in the collection bin 108 and to minimize any odours.

The fill sensor 106 can be installed on or integrated into the lid 104 in such a position that allows the fill sensor to detect the fill level of the waste receptacle 102 on which the fill sensor 106 is installed. The fill sensor 106 can detect the fill level of a smart bin 100 by detecting the distance between the lid 104 and the bottom of the waste receptacle 102, or the collection bin 108, which can vary depending on the amount of waste in the waste receptacle 102 or collection bin 108. In some examples, the fill sensor 106 is an infra-red distance sensor.

In some examples, the smart bin 100 can include additional sensors, such as proximity sensors, visual sensors (such as cameras), location sensors or temperature sensors. Such additional sensors can be integrated into the fill sensor 106 or may be separate components. Proximity sensors, visual sensors and temperature sensors can allow the smart bin 100 to monitor the surroundings of the waste receptacle. In some example embodiments, the smart bins 100 are stationary and not moveable within the premises. In other example embodiments, the smart bins 100 are not stationary and can be moved to any location throughout the premises. In such embodiments, location sensors, such as global position system (GPS) sensors or local positioning system (LPS) sensors, can detect the current location of the smart bins 100 and send the location information to the bin collection server 112. Sending the location to the bin collection server 112 allows the bin collection server 112 to continuously monitor the locations of the smart bins 100 and can update the map of the premises to show updated locations of the smart bins 100.

In some examples, the smart bins 100 include a power source (not shown). The power source can provide power to the waste receptacle 102, the lid 104 or the fill sensor 106. In some examples, the power source is a solar power source, such that the power source is capable of powering itself using ambient solar energy. In other examples, the power source can include a battery. In yet another example, the fill sensor 106 can be configured to detect a battery or charge level of the power source.

The autonomous robot 110 can use a variety of sensors in order to navigate and move throughout the premises, including proximity sensors, visual sensors (such as cameras) and accelerometers. In some examples, the autonomous robot 110 has an integrated robot control system 200 that maps and stores a map of the premises and can send this map to the bin collection server 112. In an example embodiment, the autonomous robot 110 has a scale that is configured to measure the mass of a load carried by the autonomous robot 110. In one example embodiment, the autonomous robot 110 receives real-time data (which may for example include information about distance, orientation, size, shape, and speed of a detected object) from the variety of sensors and scale and compares that sensed data against known data stored in the bin collection server 112 to identify the object and determine further attributes for the object. For example, the autonomous robot 110, having been instructed to retrieve a collection bin 108, may encounter objects such as pedestrians, furniture or other objects blocking its known path. In this regard, the autonomous robot 110 can navigate throughout the premises and avoid any objects in its path.

In some examples, the autonomous robot 110 can have a docking station where the autonomous robot 110 remains until it is instructed to retrieve one or more collection bins 108. The docking station may include a power source that allows the autonomous robots 110 to be charged while not actively collecting collection bins 108. In some examples, the bin collection server 112 is configured to generate a docking instruction to send to the autonomous robot 110, directing the autonomous robot 110 to the docking station.

The autonomous robot 110 can navigate throughout a premises, based on collection instructions sent from the bin collection server 112. Upon receiving the collection instruction, the autonomous robot 110 can navigate, using the variety of robot sensors, throughout the premises to the smart bin(s) 100 that is has been instructed to collect. When the autonomous robot 110 arrives at the indicated smart bin 100, the autonomous robot 110 can retrieve the collection bin 108. In other examples, the autonomous robot 110 can be configured to retrieve the waste receptacle 102 or the smart bin 100. Having collected the full collection bin 108, waste receptacle 102 or smart bin 100, the autonomous robot 110 can then navigate, using the various robot sensors, to the collection facility 114, where the waste and/or recycling can be deposited in the waste containers 116. In some examples, the entire collection bin 108 is picked up by the autonomous robot 110 and moved to the collection facility 114. In other examples, the autonomous robot 110 lifts the collection bin 108 and collects the waste and/or recycling from the collection bin 108, and carries the waste and/or recycling to the collection facility 114.

The bin collection server 112 is placed in a suitable area on the premises, for detecting of the fill sensors 106. The bin collection server 112 can be a cloud-based server. The system 10 illustrated in this example includes a cloud platform, which allows both the data stored in the bin collection server 112 to be accessed and stored in various locations globally, for example, using Global System for Mobile Communications (GSM), Bluetooth® Low Emission (BLE), WIFI, ZIGBEE®, SIGFOX®, or LOng RAnge (LORA®).

The bin collection server 112 is configured to communicate with a user equipment according to one or more communication protocols. The user equipment are communicably linked to the bin collection server 112. The user equipment can be computers, laptops, smart phones, cell phones, tablets or any other user equipment that allows a user to monitor the status of the smart bins 100 and provide necessary inputs, such as staff schedules, or events on the premises expected to generate a higher volume of waste. The bin collection server 112 is configured to send information from the system 10 to the user equipment.

In some examples, the bin collection server 112 communicates with the fill sensors 106, the collection facility camera 118 and the user equipment in a secured manner, for example, via secured links. The bin collection server 112 may communicate with the user equipment and fill sensors 106 via cellular communication, for example, notifying the system 10 to take certain action, such as collecting one or more of the collection bins 108 from the full smart bins 100. The bin collection server 112 may provide a user interface, such as a web-portal, API, analytics software or a dashboard for the user equipment to connect to and control the system 10. The bin collection server 112 may include a memory for storing data from the fill sensors 106, the user equipment, or the collection facility camera 118. The bin collection server 112 may also store software updates to the system 10 and notify the user equipment, for example by using a flag to indicate that a software update is available. A user equipment may check the status of the software or the flag for software update in the bin collection server 112. The bin collection server 112 may also notify a user equipment with the sensed results from the system 10, for example, by emails or short messages. The user equipment may download the software from the bin collection server 112 via a suitable communication modality over the Internet, for example at M1 Long-Term Evolution (LTE), Narrowband Internet of Things (NB-IOT), or second Generation (2G) to fifth Generation (5G), or other wireless communication modalities.

By communicating with the user equipment, users are able to monitor various aspects of the system 10, including the real-time fill levels of each smart bin 100; temperature of each smart bin 100; power or charge level of the fill sensors 106 and/or the smart bins 100; bin classifications (i.e. General Rubbish, Recycling Plastic, Recycling Paper, Recycling Glass, Recycling electronics, Recycling Clothing, etc.); the dynamic fill sensor 106 scheduling (i.e. the wake up schedule for the fill sensors 106); the dynamic staff collection scheduling (i.e. adjusting staff and waste collection schedules based on the demands of the waste management on the premises); and the routes generated by the route management module 120. The bin collection server 112 can also convert the information received from the fill sensors 106 into more desirable values, for example the bin collection server 12 may receive the distance sensed from the fill sensor 106, indicating the distance to the bottom of the waste receptacle, and can then convert that distance into a fill percentage such that users of the system have a better understanding of the amount of waste in a smart bin 100. The bin collection server 112 can also generate reports at various intervals (i.e. daily, weekly, monthly, annually etc.) and these reports can include various information about the system including the total volume of waste generated based on the day of the week (or year), time of day, type of waste etc.; most used smart bins 100; staff efficiency; and missed waste pickups.

The bin collection server 112 is configured to communicate with the fill sensors 106 and the autonomous robots 110, for example, by sending commands to and by receiving the sensed data from the autonomous robots 110 and the fill sensors 106. The bin collection server 112 can receive and store information from the fill sensors 106, such as a fill level or the temperature of the corresponding smart bin 100. For example, in the example configuration depicted in FIG. 1, the fill sensors 106 would indicate that one smart bin 100 is empty, one smart bin 100 is full (i.e. 100%) and another smart bin is approximately 90% full. The fill sensors 106 can also detect other conditions of the smart bin 100, for example a bin ID (i.e. a name, location, identification number etc.), a bin type (e.g. trash, paper recycling, compost/organic materials, plastics recycling, glass and/or bottle recycling), the temperature of the smart bin 100, the battery or charge level of the power source, or a signal strength from the fill sensor 106 to the bin collection server 112. When the fill sensors 106 are configured to detect these other conditions, the fill sensors 106 can also be configured to communicate these conditions to the bin collection server 112.

Having received fill levels of the smart bins 100, as well as other conditions of the smart bins 100, the bin collection server 112 can determine whether each smart bin 100 should be emptied. For example, the bin collection server 112 can receive a fill level from fill sensor 106 of a smart bin 100, indicating that the smart bin 100 is full or greater than a threshold fill level. The bin collection server 112 can then create a collection instruction to send to an autonomous robot 110. The collection instruction can include the location of the bin, the bin ID, the type of bin (e.g. trash, recycling, organic materials), and an instruction to collect the collection bin 108 from the smart bin 100 and to bring the collection bin 108 to the collection facility 114.

In some examples, the bin collection server 112 can instruct the autonomous robots 110 to collect only collection bins 108 from smart bins 100 that have reached a 100% fill level. The autonomous robot 110 can collect a single collection bin 108 or multiple collection bins 108, which is a factor that the bin collection server 112 can consider when instructing the autonomous robots 110 to collect collection bins 108.

In some examples, the bin collection server 112 includes a real time map of the premises, which can be updated based on the information and data received from the fill sensors 106, the collection facility camera 118 and the autonomous robot 110. For example, the real time map can include the real time location of each autonomous robot 110, the fill levels, bin IDs, bin type etc. of each of the smart bins 100. The bin collection server 112 can generate a map of the premises or the bin collection server 112 can use a known map of the premises as a starting point in which the known map is then populated in real time with locations of the collection bins 108 and the autonomous robots 110, to generate the real time map. The map of the premises can be stored in the bin collection server 112, or the bin collection server 112 can obtain the map of the premises from a GPS or mapping service.

In some examples, the bin collection server 112, can include a route management module 120. The route management module 120 can include a machine learning model. In some examples, the bin collection server 112 can determine a route or several routes for the autonomous robots 110 to use when collecting the smart bins 100. In the example configuration depicted in FIG. 1, the bin collection server 112 receives the fill levels from the smart bins 100 indicating that at least one smart bin 100 was full and needed to be emptied. In such an example, the bin collection server 112, using the route management module 120, can determine which autonomous robot 110 is nearest to the smart bins 100 that must be emptied, determine an efficient route for the autonomous robot 110 to take and send a collection instruction, including the route, to the autonomous robot 110.

The machine learning model can include a neural network running on a computing platform such as the bin collection server 112. Neural networks will be briefly described in general terms. A neural network can include multiple layers of neurons, each neuron receiving inputs from a previous layer, applying a set of weights to the inputs, and combining these weighted inputs to generate an output, which can in turn be provided as input to one or more neurons of a subsequent layer. The neural network is formed by joining a plurality of the foregoing single neurons. In other words, an output from one neuron may be an input to another neuron. An input of each neuron may be associated with a local receiving area of a previous layer, to extract a feature of the local receiving area. The local receiving area may be an area consisting of several neurons.

In order to generate the routes, the machine learning model needs to be trained and tested. In the example of a neural network, training a neural network involves learning or determining the appropriate weight values at different weight locations throughout the network. After being optimally trained to perform a given inference task, the weights of the neural network will not all contribute equally to the final inference outputs: some weights will have high value due to their high contribution, while other weights will have low value due to their low contribution. If the weights are not properly trained (e.g., high value weights are misplaced or miscalibrated by training), then the trained network will perform with less accuracy. In the system 10, the neural network can be trained using a suitable set of training data including data obtained from each of the fill sensors 106, the collection facility camera 118 and the autonomous robots 110.

The route management module 120 can generate routes for both the autonomous robots 110 and staff on the premises, for example, when the waste collection on the premises is done by both autonomous robots 110 and staff. Each of the routes generated by the route management module 120 can be added to the real-time map. By monitoring the routes on the real-time map, newly filled collection bins 108 can be added to a route if the autonomous robot 110 has additional capacity to take an extra collection bin 108, or can alter the routes to include such a newly filled collection bin 108. In another example, the bin collection server 112 may receive a staff schedule, indicating the number and duties of waste management staff on the premises at a given time. The route management module 120 can use the staff schedule to create more efficient routes for either the staff, the autonomous robots 110 or both, to optimize the scheduling of waste collection and to group staff and/or autonomous robots 110 for each route generated. The routes generated by the route management module 120 can be included in the collection instruction sent to the autonomous robot 110.

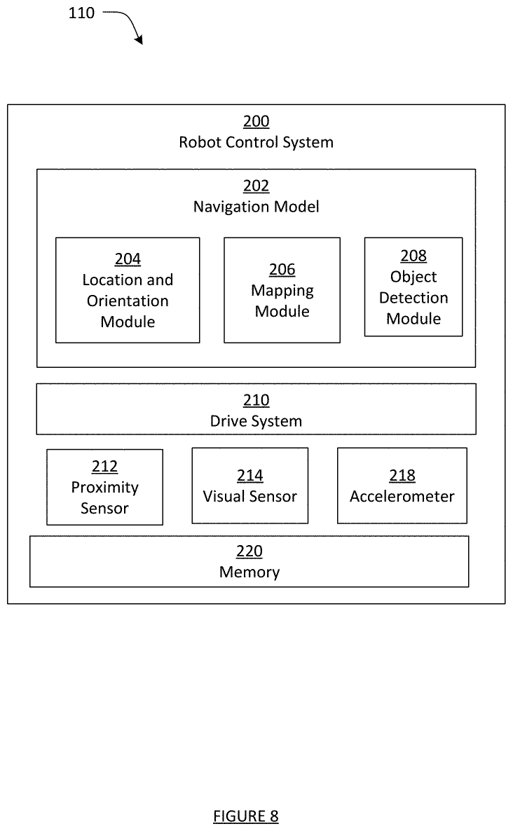

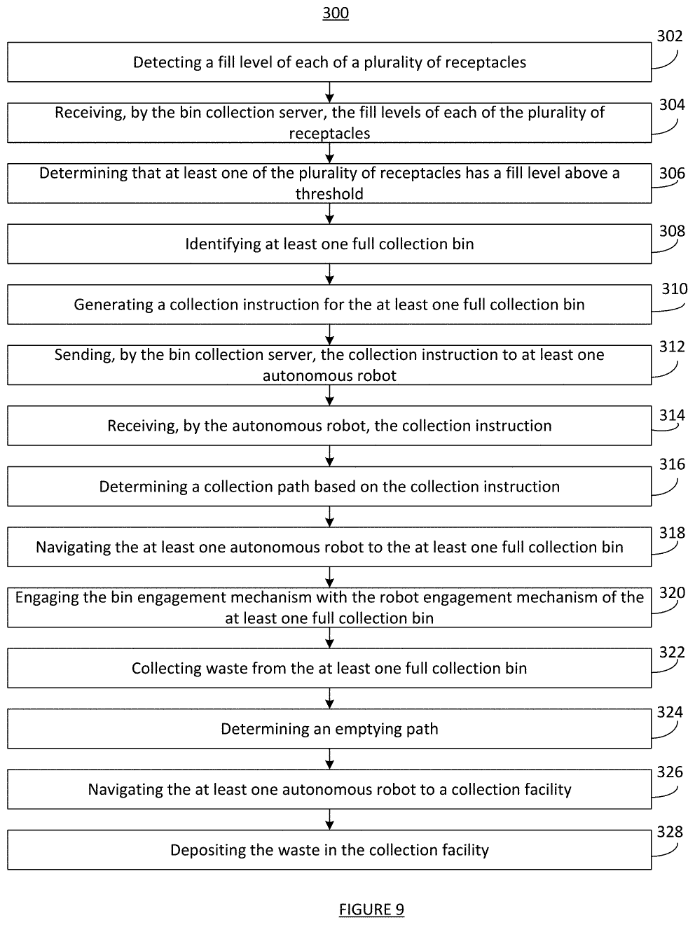

The autonomous robot 110 can include a navigation model 202, as depicted in FIG. 8. In some examples, the autonomous robot 110 includes a global positioning system (GPS) sensor. The navigation model 202 can receive instructions from the bin collection server 112. For example, the bin collection server 112 can instruct the autonomous robot 110 to retrieve a full collection bin 108 based on a bin ID associated with the collection bin 108. The autonomous robot 110, using the navigation model 202, can communicate directly with the fill sensor 106 of the collection bin 108 to be picked up to determine the location of the collection bin 108. The autonomous robot 110 can then determine a path to the collection bin 108 using the navigation model 202 and navigate along the path. While traveling along this path, the autonomous robot 110 can monitor for objects in or near its path and alter its path, if necessary, and send the information collected about the object (for example, size, shape, speed, location) to the bin collection server 112.

In some examples there may be several different type of bin types, such as trash, paper recycling, organic materials etc. When there are several different types of bins, the route management module 120 can determine the bins of a certain type that need to be emptied, and can generate a route for one or more autonomous robots 110 to collect the bins of that type. The route management module 120 can also consider other factors, such as the general location of the smart bins 100 that must be collected, bin type, proximity of each smart bin 100 to the collection facility(s) 114, temperature of the smart bins 100, proximity and number of autonomous robots 110 to the smart bins 100 that must be emptied, or the fill levels of nearby smart bins 100. For example, in the configuration depicted in FIG. 1, the route management module 120 may generate a route that includes collecting the collection bin 108 from both the 100% full smart bin 100, and the 90% full smart bin 100, for example if the temperature of the 90% full bin has surpassed a threshold, or if the route management module 120 predicts that the 90% full bin will be 100% full shortly.

The bin collection server 112 can receive the fill level of the smart bin 100 and the other conditions from the fill sensors 106. In some examples, the bin collection server 112 can include a wake up schedule, which can indicate the frequency or the times of day that the fill levels of the smart bins 100 should be checked by their corresponding fill sensors 106. The wake up schedule can be a pre-determined schedule, such as every other hour during a week day and once a day on the weekends. In another example, a user can provide inputs for the wake up schedule, or can alter existing schedules using their user equipment. In other examples, the bin collection server 112 can determine, using a machine learning model, a wake up schedule based on the speed with which certain smart bin(s) 100 reach a 100% fill level, the times of day or days of the week that certain smart bin(s) 100 reach a 100% fill level, and the available nearby or available resources, including the autonomous robots 110 and staff on the premises.

In another example, the fill sensors 106 can continuously send the fill level and other detected conditions of the smart bins 100 to the bin collection server 112. By continuously monitoring the fill level and other conditions of the smart bins 100, the bin collection server 112 can monitor the waste collection system in real time and determine improvements such as more efficient wake up schedules or more accurate the frequency at which the collection bins 108 are retrieved by the autonomous robots 110.

A user can monitor the system 10 using the user equipment and make changes to the system based on the information provided by the system. For example, if a certain floor of a building produces a substantial amount of waste, the user can direct the bin collection server 112 to dedicate more staff and/or autonomous robots 110 to that floor. The user can also use the information provided about the system 10 to make changes to the overall waste management system. For example, it may become apparent that a certain floor or area of the premises requires substantially more smart bins 100 for paper recycling than are currently present, allowing the user to reconfigure the locations of the smart bins 100

In some examples, the bin collection server 112 uses distributed ledger technologies, such as ETH, R3, Corda or IOTA. When using distributed ledgers, the bin collection server 112 views the changing of a collection bin 108 in a smart bin 100 as a transaction between the autonomous robot 110 and the user of the system (i.e. the owner of the premises).

In an example, the collection facility 114 is generally the central waste management area of the premises. For example, many buildings have a central location where all waste is collected and brought to be collected in waste containers 116. In other examples, there may be specific collection facilities 114 that vary depending on the type of waste, i.e. trash, recycling or organic materials or there may be several collection facilities 114 to cover a larger premises.

The autonomous robots 110, having collected one or more full collection bins 108a, can then navigate to the collection facility 114. In some examples, the autonomous robots 110 can deposit the full collection bins 108a in the collection facility 114 to be emptied by waste management staff into a waste container 116. In other examples, the collection facility 114 is equipped to receive the full collection bins 108a, empty their contents into the corresponding waste container 116 and place the now empty collection bins 108b in a location to be collected by the autonomous robots 110 and replaced into the waste receptacles 102 of the smart bins 100. In yet another example, the collection facility 114 can be equipped to automatically wash the collection bins 108 after emptying their contents into the waste containers 116.

After the collection bins 108 have been emptied into the waste containers 116, the empty collection bins 108b can be deposited in a location to be retrieved by autonomous robots 110 and returned to the smart bins 100. The collection instruction sent to the autonomous robots 110 from the bin collection server 112 can include an instruction to retrieve an empty collection bin 108b and return the empty collection bin 108b to the smart bin(s) 100 that were just collected, or to other smart bins 100 that are currently being emptied. The route management module 120 can include replacing empty collection bins 108b into empty smart bins 100 in addition to, or separate from, the collection of full collection bins 108a.

The collection facility 114 can have a collection facility camera 118. The collection facility camera 118 can be directed to view the waste containers 116 in the collection facility 114. The collection facility camera 118 detects the fill levels of the waste containers 116. In some examples, the collection facility camera 118 uses a machine learning model, particularly machine learning image recognition, to detect the fill level of the waste containers 116.

There may be at least one or any number of collection facility cameras 118 in the collection facility 114. For example, if there are several waste containers 116, there may be a collection facility camera 118 corresponding to each waste container 116. In other examples, there may be several collection facility cameras 118 dedicated to each waste container 116, to provide a more accurate fill status of the waste container 116.

The collection facility camera 118 is able to communicate with the bin collection server 112, to send the fill status of the waste containers 116. In some examples, the bin collection server 112, upon receiving the fill status of the waste containers 116, can dispatch the appropriate waste collection company to come to the premises and collect the waste contained in the waste container. For example, if the collection facility camera 118 detects that the waste container 116 for collecting paper recycling is full, the bin collection server 112 can contact the local entity responsible for paper recycling to come to the premises and empty the waste container 116 for paper recycling. In another example, the bin collection server 112 can notify a user, through their user equipment, that a waste container 116 is full and instruct the user to contact the local waste collection entity.

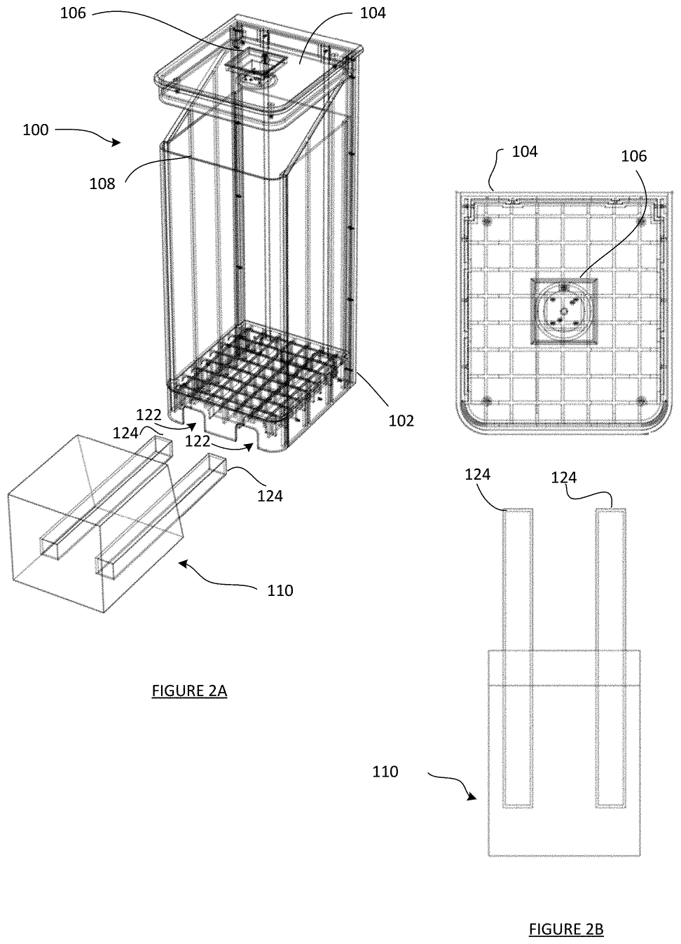

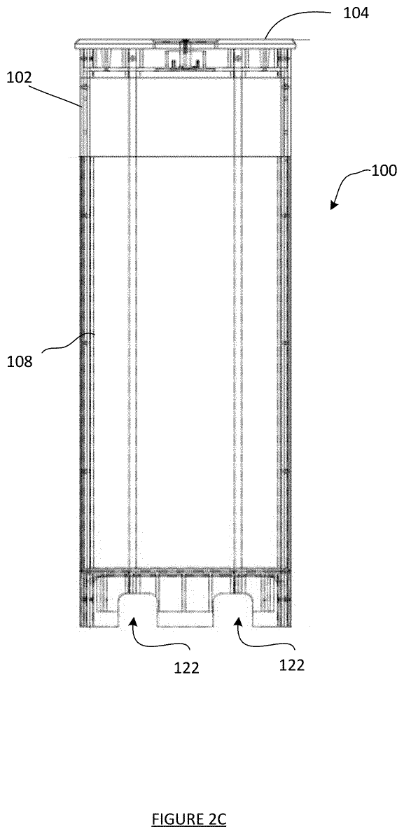

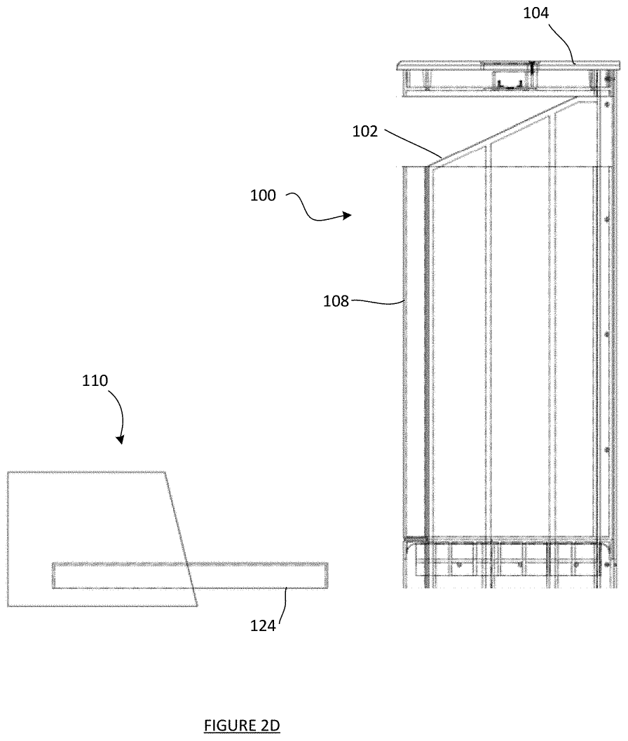

FIGS. 2A, 2B, 2C, 2D, 3A, 3B, 3C, 3D, 4A, 4B, 4C, 4B, 5A, 5B, 5C, 5D, 6A, 6B, 6C, 6D, 7A, 7B, 7C, and 7D illustrate exemplary embodiments of the smart bin 100 and the autonomous robot 110.

In some examples, such as those depicted in FIGS. 2A, 2B, 2C, 2D, 3A, 3B, 3C, 3D, 4A, 4B, 4C, and 4B, the autonomous robot 110 can have a bin engagement mechanism in the form of at least one prong 124, extending outwards from one side of the autonomous robot 110. In an example, the prong(s) 124 can generally be oriented horizontal to the ground, but may be oriented in any way that allows sufficient engagement with the opening(s) of the collection bins 108. Each collection bin 108 can have at least one opening 122 each for receiving a respective one of the prong(s) 124. When an autonomous robot 110 has been instructed to retrieve a collection bin 108 from a smart bin 100, the autonomous robot 110 can approach the smart bin 100 from the front of the smart bin 100, with the prong(s) 124 facing the openings 122 of the smart bin 100. The autonomous robot 110 can move forward such that the opening(s) 122 in the collection bin 108 can receive the prong(s) 124. Once the prong(s) 124 are in place, the autonomous robot 110 can engage a servo motor, allowing the autonomous robot 110 to apply an upwards force on the collection bin 108, lifting the collection bin 108 from the waste receptacle 102 of the smart bin 100. In some examples, the autonomous robot 110, having lifted the collection bin 108, can move backwards in a direction away from the smart bin 100 in order to remove the collection bin 108 from the waste receptacle 102. In some examples, the collection bin 108 and the waste receptacle 102 are integrated into a single component, such that when the autonomous robot 110 retrieves the collection bin, the entire waste receptacle 102 is collected as well. Having removed the collection bin 108 from the smart bin 100, the autonomous robot 110 can navigate throughout the premises while carrying the collection bin 108. The autonomous robot 110 can also use the scale to determine the mass of the collection bin 108. The autonomous robot 110 can have a predetermined load mass and once the mass of the load being carried by the autonomous robot 110 (for example, the collection bin(s) 108 and the waste therein) exceeds the predetermined load mass, the autonomous robot 110 can navigate to the collection facility 114.

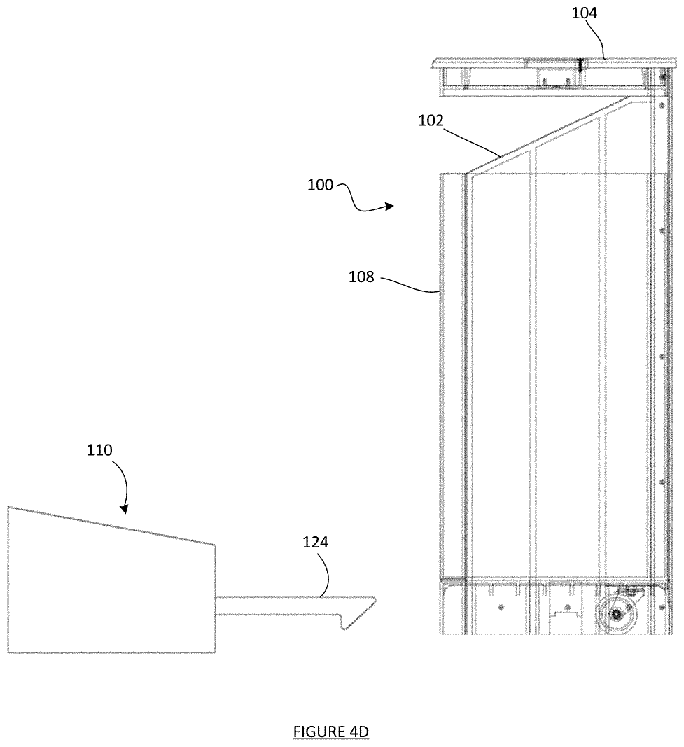

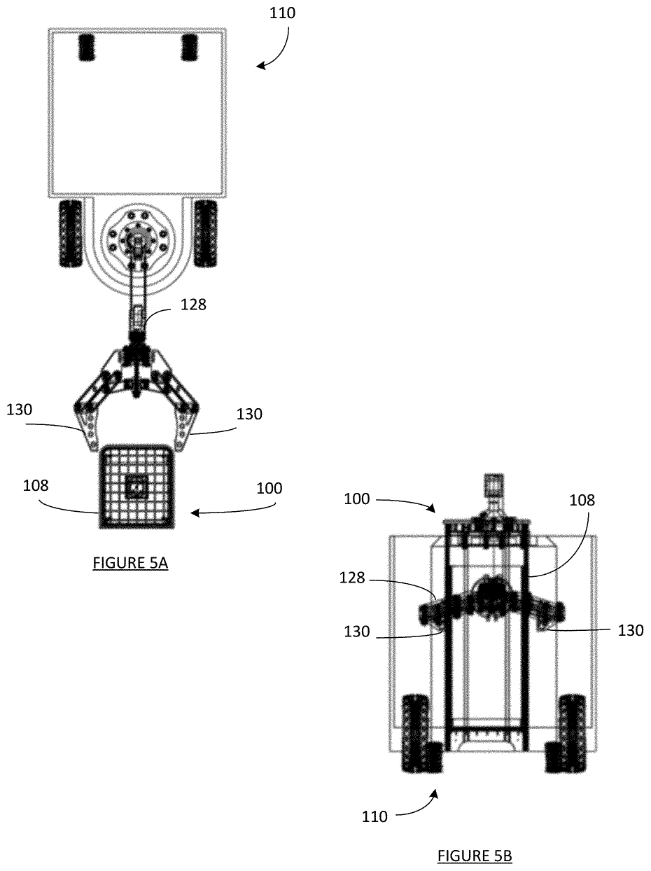

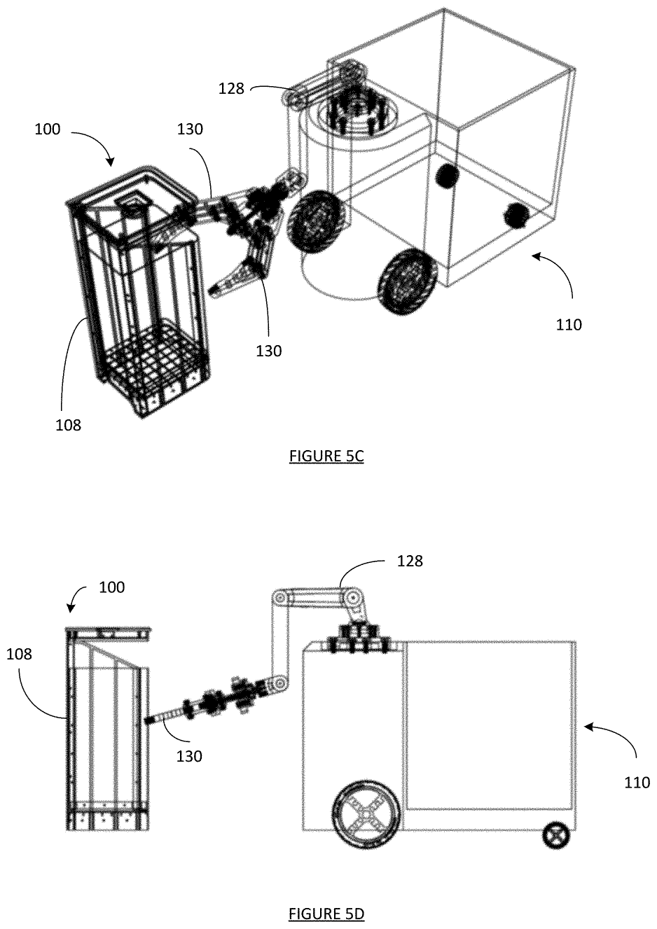

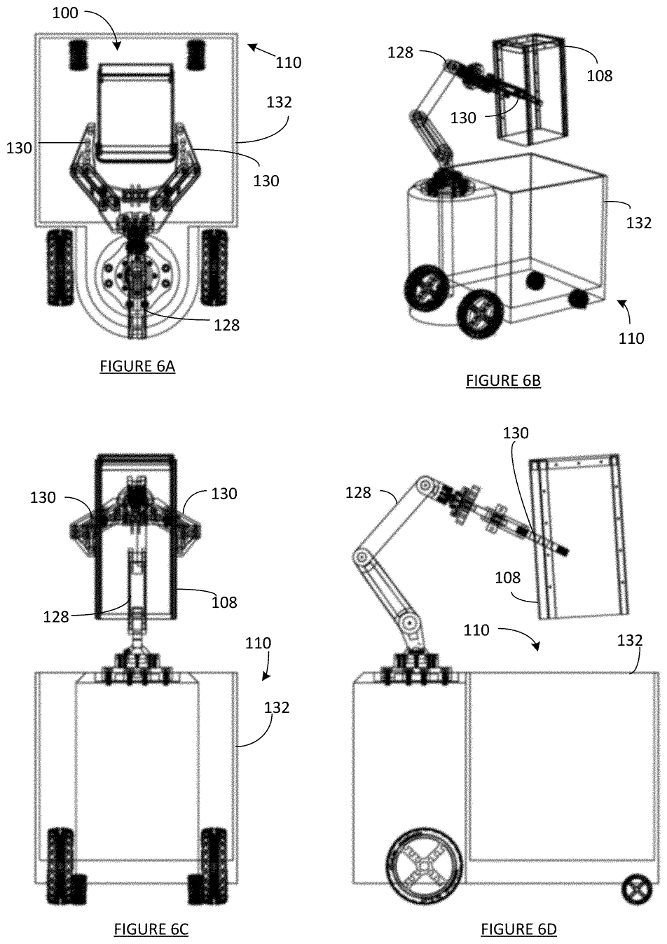

In other examples, the autonomous robot 110 will have a bin engagement mechanism that includes a gripping arm 128, as shown in FIGS. 5A, 5B, 5C, 5D, 6A, 6B, 6C, and 6D. The gripping arm 128 can have at least two fingers 130 that the autonomous robot uses to engage the collection bin 108. The gripping arm 128 can move in a variety of directions from its attachment point on the autonomous robot 110. When an autonomous robot 110 has been instructed to retrieve a collection bin 108 from a smart bin 100, the autonomous robot 110 can approach the smart bin 100 from the front of the smart bin 100, with the gripping arm 128 facing the collection bin 108. The autonomous robot 110 can then move itself forward or the gripping arm 128 forward such that the fingers 130 are located on either side of the collection bin 108. In order to collect the waste from the smart bin 100, the autonomous robot 110 can then apply a gripping force that moves the fingers 130 towards the collection bin 108 until they engage the collection bin 108. In some examples, the collection bin 108 will have mechanisms for attaching to the fingers 130, such as mechanical clasps, magnets or slots. In another example, the autonomous robot 110 applies a sufficiently large force to the collection bin 108 through the fingers 130 such that the autonomous robot 110 can lift the collection bin 108.

In some examples, the autonomous robot 110 has a robot waste bin 132, as shown in FIGS. 6A, 6B, 6C, and 6D. When the autonomous robot 110 has a robot waste bin 132, the autonomous robot 110 does not need to lift and carry the full collection bin 108a to the collection facility 114. Instead, the autonomous robot 110 can engage the bin engagement mechanism with the robot engagement mechanism of the full collection bin 108a, lift the full collection bin 108a, and deposit the waste contained in the full collection bin 108a into the robot waste bin 132. The autonomous robot 110 can then return the now empty collection bin 108b to the waste receptacle 102. In some examples, the autonomous robot 110 can navigate to multiple smart bins 100 to collect the waste from their respective collection bins 108 and detect when the robot waste bin 132 is full. For example, the autonomous robot 110 can use the scale to measure a mass of the robot waste bin 132 and the waste therein, and determine whether the load mass has exceeded a predetermined load mass. The autonomous robot 110 can then determine that the robot waste bin 132 is full, for example when the autonomous robot 110 detects a mass equal to or greater than the predetermined load mass. When the robot waste bin 132 is full, the autonomous robot 110 can navigate to the collection facility 114 to deposit the waste,

When replacing an empty collection bin 108b in a smart bin 100, the autonomous robot 110 can perform the reverse. The empty collection bin 108b can be raised up by the autonomous robot 110 during transportation from the collection facility 114 to the smart bin 100. The autonomous robot 110 can approach the smart bin 100 from the front side of the smart bin 100, with the collection bin 108 raised. Once the autonomous robot 110 has moved forward and the collection bin is aligned inside the waste receptacle 102, the autonomous robot 110 can lower the collection bin 108 into the waste receptacle 102. Having properly placed the collection bin 108 in the waste receptacle 102, the autonomous robot 110 can move in a direction away from the front of the smart bin 100 and move to its next location. In some examples, the autonomous robot 110 can have a new or additional collection instruction from the bin collection server 112, in which case the autonomous robot 110 can navigate to the next indicated smart bin 100 that must be emptied. In other examples, the autonomous robot 110 does not have any additional collection instructions, in which case the autonomous robot 110 can navigate itself back to the docking station until the next collection instruction is received.

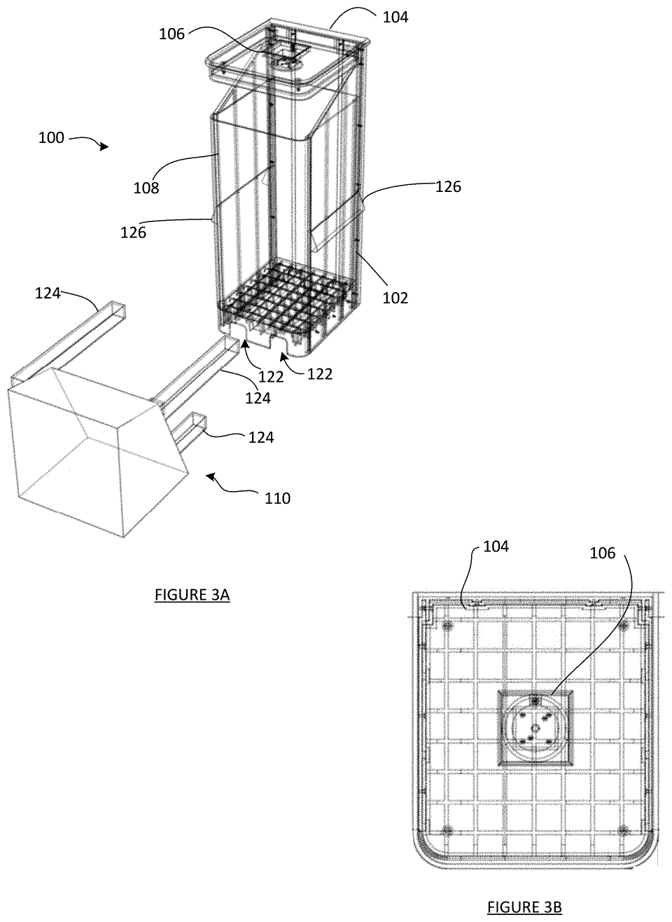

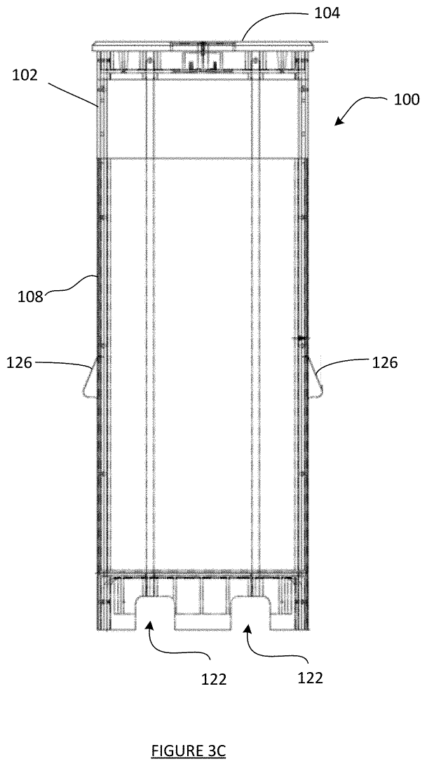

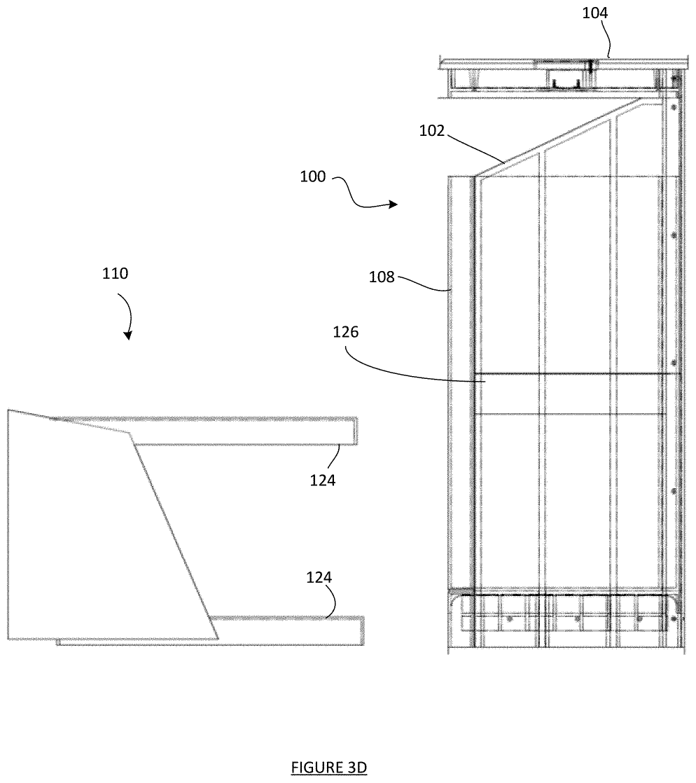

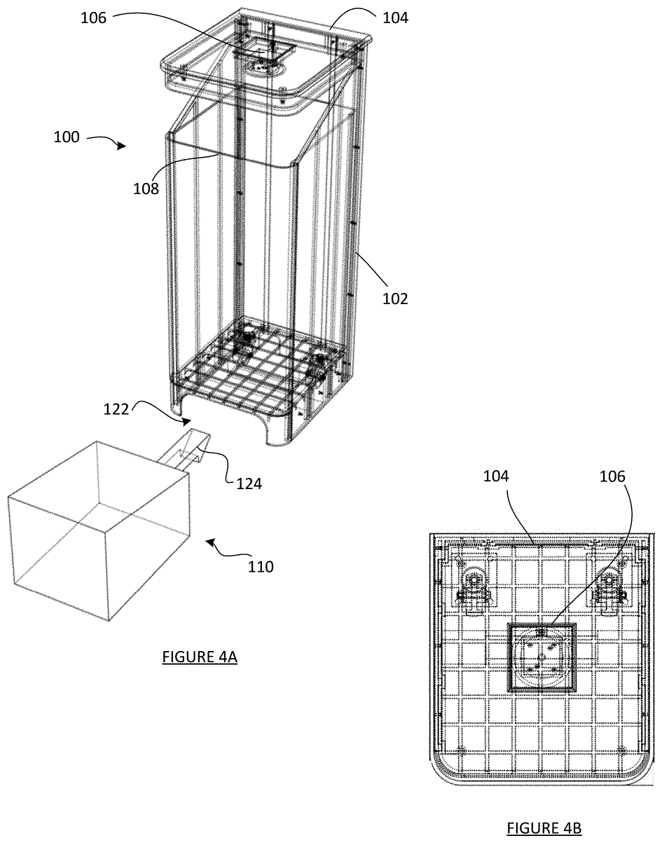

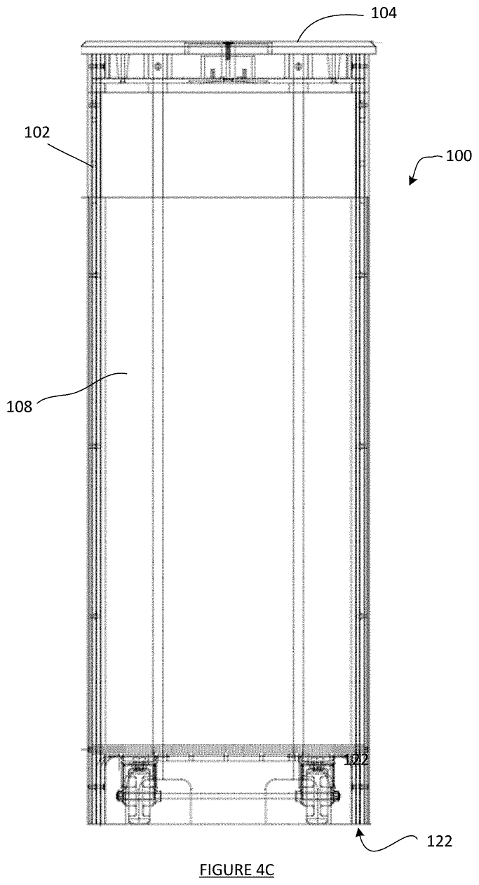

In some examples, the autonomous robot 110 has a single prong 124, as seen, for example, in FIG. 4A. In other examples, the autonomous robot may have several prongs 124, as seen, for example, in FIGS. 2A and 3A. Similarly, the collection bin 108 may have a single opening 122 for receiving the prong(s) 124, or may have several openings 122, corresponding to each of the prong(s) 124, as can be seen, for example, in FIGS. 2A, 3A and 4A.

In some examples, the prong(s) 124 and the opening(s) 122 include magnets, allowing the prong(s) 124 to magnetically connect with the collection bin 108 through the opening(s) 122. By magnetically connecting the prong(s) 124 to the collection bin 108, the autonomous robot 110 can maintain a more stable connection with the collection bin 108 while navigating to the collection facility 114. In other examples, the autonomous robot 110 can use a mechanical clasp to engage with the underside of the collection bin, in order to similarly stabilize the collection bin 108 on the autonomous robot 110 while the collection bin 108 is being taken to the collection facility 114. In other examples, the prongs 124, openings 122 and collection bin 108 can include any other connection means that ensure the collection bin 108 is stabilized during transportation and allows the autonomous robot 110 to insert the prongs 124 into the openings 122 and raise, lower and carry the collection bin 108.

In some examples, the collection bin 108 has flanges 126 located on one or more sides of the collection bin 108, as can be seen in FIGS. 3A and 3D. When the collection bin 108 has flanges 126, the prongs 124 can be configured to be received by the flanges 126, in a similar manner to the opening(s) 122. The prong(s) 124 can be positioned under the flanges 126 such that they engages with the flanges 126 when the autonomous robot 110 lifts the collection bin 108.

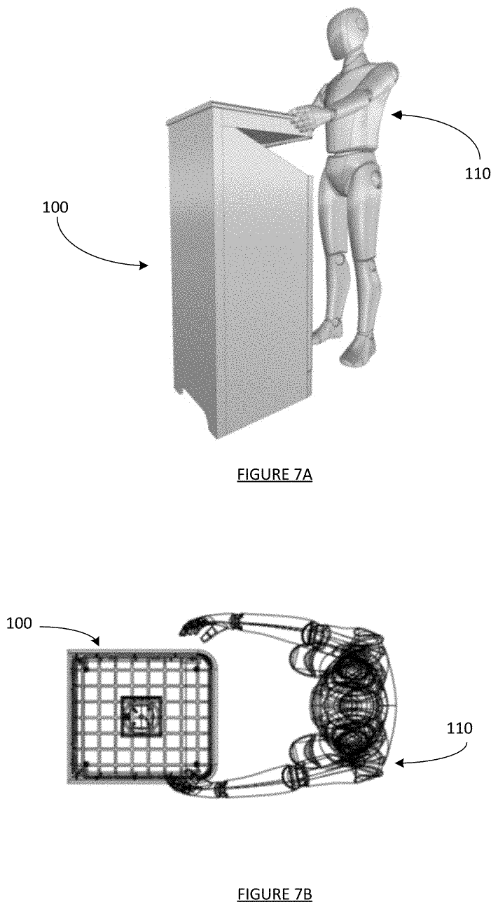

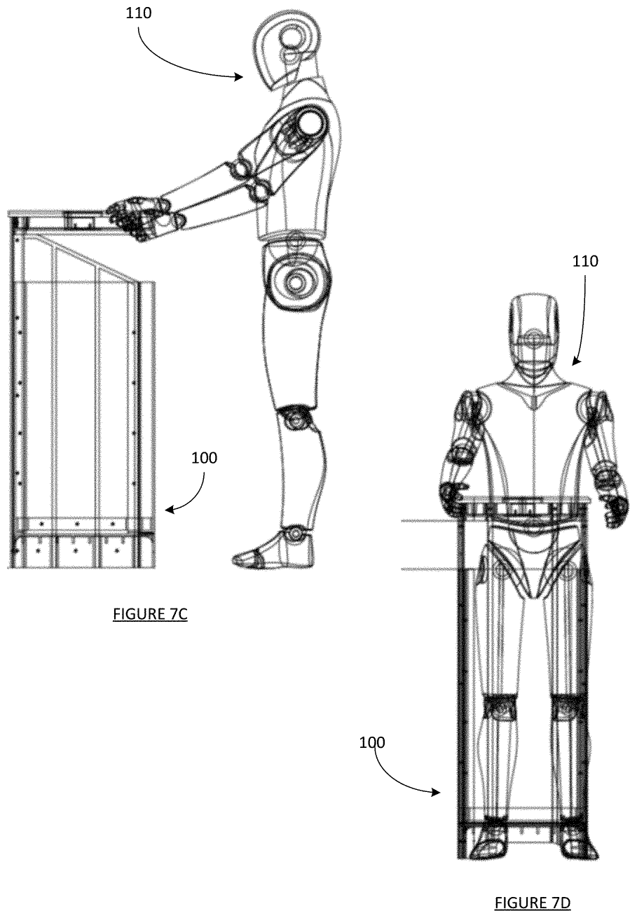

In another example, the autonomous robot 110 is in the form of a humanoid robot, as depicted in FIGS. 7A, 7B, 7C, and 7D. The humanoid autonomous robot 110 can navigate throughout the premises by simulating a human walking and can grasp and lift the collection bins 108 by simulating a human carrying the collection bin 108.

FIG. 8 illustrates the robot control system 200 for the autonomous robot 110. The robot control system 200 can include a navigation model 202, a drive system 210 and several sensors including a proximity sensor 212, a visual sensor 214, an accelerometer 218 and a memory 220. The proximity sensor 212 can detect the proximity of the autonomous robot 110 to another object, for example walls, pedestrians, furniture, stairs, doors. The visual sensor 214 can include a camera for observing the environment surrounding the autonomous robot 110. The robot control system 200 can also include additional sensors, such as a global positioning system (GPS) sensor, or a local positioning system (LPS) sensor. Using the robot control system 200, the bin collection server 112 can be in constant communication with the autonomous robot 110.

The robot control system 200 can use the navigation model 202 to determine, modify and update the navigation path for the autonomous robot 110. In some examples, the navigation model 202 is a machine learning model. The robot control system 200 can include a reference dataset stored in the memory 220, that is obtained from the bin collection server 112, comprising information such as the known map of the premises, the locations of known objects on the premises, and the status of one or more of the smart bins 100. The robot control system 200 can also include computer executable instructions that are stored in the memory 220 that configures the autonomous robot 110 to perform the functions described herein.

In at least some example embodiments, a training dataset is also stored in memory 220. The training dataset includes a base set of data that the robot control system 200, and in particular the navigation model 202, can build on and refine to create and update object reference dataset. In some embodiments, the training dataset may be augmented with data obtained from one or more of the robot sensors to improve location and orientation detection, mapping and object detection.

The navigation model 202 can include a location and orientation module 204, a mapping module 206 and an object detection module 208. The location and orientation module 204 can receive information from the various sensors in the robot control system 200 in order to determine the real time location and orientation of the autonomous robot 110. The location and orientation module 204 can continuously monitor the real time location and orientation of the autonomous robot 110. In some examples, the robot control system 200 is configured to send the real time location and orientation of the autonomous robot 110 to the bin collection server 112.

The navigation model 202 can also include a mapping module 206. The mapping module 206 can receive a map of the premises from the bin collection server 112. The mapping module 206 can use the map of the premises, in addition to the various sensors (such as the proximity sensor 212, the visual sensor 214 and the accelerometer 216) in order to determine a path for the autonomous robot 110 to move along. For example, if the autonomous robot receives a collection instruction from the bin collection server 112 to collect a collection bin 108, the mapping module 206 can be used to determine the most efficient, least obstructive route to that collection bin 108.

In some examples, the collection instruction can include an optimized route generated by the bin collection server 112. Upon receiving an optimized route from the bin collection server 112, the mapping module 206 can direct the autonomous robot 110 to travel along the path, and modify or update the path as the autonomous robot 110 travels along the path, based on its sensed surroundings. If the path becomes obstructed, the autonomous robot 110 can sense the obstruction, for example using the proximity sensor 212. In other examples, the mapping module 206 can generate or update a path based on information the autonomous robot 110 has sensed or obtained from the bin collection server 112. For example, if a path directs the autonomous robot 110 through a heavily trafficked area of the premises, the mapping module 206 can modify the path to move through the area in the least trafficked section of that area, or modify the path to take a longer, less trafficked route, for example around the periphery of a room.

The mapping module 206 can also monitor the current location of the autonomous robot 110 on the map of the premises and send updated location information to the bin collection server 112. The mapping module 206 can also update the map of the premises stored in the bin collection server 112 based on the sensed surroundings of the autonomous robot 110. For example, if a piece of furniture has recently been moved on the premises, the autonomous robot 110 can detect the size, location and orientation of the piece of furniture using the location and orientation module 204 and the object detection module 208 and send that information to the bin collection server 112. By sending the updated information regarding a piece of furniture to the bin collection server 112, the map of the premises maintained on the bin collection server 112 will remain up to date and future routes generated or modified can avoid any new obstructions.

The object detection module 208 allows the autonomous robot 110 to monitor its surroundings and detect nearby objects. The object detection module 208 uses the various robot sensors, including the proximity sensor 212, the visual sensor 214 and the accelerometer 218, to detect the proximity to certain objects and identify the object. For example, the object detection module 208 can use the various robot sensors to distinguish between a moving object, such as a person, and a stationary object, such as a wall or a piece of furniture. The object detection module 208 can also identify whether an object is likely to remain in its place, such as a wall, or whether the object may be moved in the future, such as a piece of furniture. The object detection module 208 can then communicate with the mapping module 206 and the location and orientation module 204 in order to determine the location on the premises of the detected object.

The robot control system 200 also includes a drive system 210 that is used by the autonomous robot 110 to move the autonomous robot 110 along the various routes. For example, when the autonomous robot 110 receives a collection instruction, the navigation module 202 can determine the necessary movements in order to navigate along the necessary route and can communicate such movements to the drive system 210. The autonomous robot 110 can then use the drive system 210 to move to the desired location, for example to a full smart bin 100. The drive system 210 can include drive wheels, drive motors, chassis and any additional components that can assist the autonomous robot 110 in moving throughout the premises. In some examples, the drive system 210 is configured to move the autonomous robot 110 at a consistent or pre-determined speed. In other examples, the navigation model 202 can monitor the surroundings and continuously determine an appropriate speed for the autonomous robot 110. For example, if the autonomous robot 110 is moving and approaches a slow moving group of people that the autonomous robot 110 cannot avoid by moving around, the navigation model 202 can modify the speed to ensure no collision with the slow moving group of people.

FIG. 9 illustrates a method 300 for autonomous robotic waste collection using the system 10. At step 302, the fill sensor 106 of each of the smart bins 100 detects a fill level of each of the collection bins 108. The fill levels may be in the form of a distance from the top of the collection bin 108 to the fill sensor 106, or they may be converted to a percentage or other format.

Upon detecting the fill level of each of the collection bins 108, the fill levels are sent to the bin collection server 112 at step 304. The bin collection server 112 can store the fill levels and monitor fill levels throughout the day, week or other time period. By monitoring the fill levels over a period of time, the bin collection server 112 can predict when certain smart bins 100 will be full and can make recommendations, for example, suggesting that more smart bins 100 be moved to a particular area of the premises where the collection bins 108 are most frequently filled.

At step 306, the bin collection server 112 determines whether the fill levels any of the collection bins 108 have passed a threshold. For example, where the fill level has been converted to a percentage, the threshold may be 90% or 100% or any other value that may be pre-determined by the bin collection server 112 or set by a user of the system 10. In some examples, the threshold value is the same for each collection bin 108 in the system 10. In other examples, the threshold value may vary based on the bin type, location, sensed temperatures or other characteristics. For example, organic waste bins may generate more odours if left partially filled and thus may need to be emptied more frequently than other bin types, such as paper recycling, In this regard, the bin collection server 112 may have a lower threshold value for organic waste collection bins 108 in order to ensure that the organic waste collection bins 108 are collected more frequently.

In another example, the bin collection server 112 can be configured to receive the temperature of a smart bin 100 and its surroundings and, based on that temperature, alter the threshold value. For example, if a smart bin 100 is in a location on the premises with a higher temperature, the bin collection server 112 can identify when the temperature of the smart bin 100 is too high such that the bin should be emptied immediately to avoid odours. In this case, the bin collection server 112 can lower the threshold value to ensure that the collectable bin 108 is emptied sooner.

At step 308, the bin collection server 112 identifies the collection bin 108 with a fill level that has passed the threshold value. Based on the identified full collection bins 108a, the bin collection server 112 generates a collection instruction at step 310. The collection instruction can include a variety of information for the autonomous robot 110, including the identities and locations of the full collection bin(s) 108a, preferred routes to the full collection bin(s) 108a, when the full collection bin(s) 108a should be collected and the location of the collection facility 114 that the full collection bin(s) 108a are to be brought to. Any information that may be necessary for navigating the autonomous robot 110 to the full collection bin(s) 108a can be included in the collection instruction.

At steps 312, the bin collection server 112 sends the collection instruction to the autonomous robot 110 which receives the collection instruction at step 314. Using the collection instruction, the autonomous robot 110 can determine a path to the full collection bin(s) 108a, using the robot control system 200. In some examples, the path can be included in the collection instruction based on the route generated by the bin collection server 112. When the route is included in the collection instruction, the autonomous robot 110 can be configured to follow that route and only alter the path when necessary, for example, when an object is detected as obstructing the path. In other examples, the robot control system 200 can receive the map of the premises and determine the path using the navigation model 202.

Having determined the path to take, the autonomous robot then navigates to the full collection bin(s) 108a using the drive system 210 at step 318. Once the autonomous robot 110 arrives at a full collection bin 108a, the autonomous robot 110 is configured engage the bin engagement mechanism with the robot engagement mechanism of the full collection bin 108a, as discussed in relation to FIGS. 2A, 2B, 2C, 2D, 3A, 3B, 3C, 3D, 4A, 4B, 4C, 4D, 5A, 5B, 5C, 5D, 6A, 6B, 6C, 6D, 7A, 7B, 7C, and 7D, at step 320. This step may include inserting the prong 124 into the openings 122 of the collection bin 108. In other examples, this step includes gripping the collection bin 108 with the fingers 130 of the gripping arm 128. When the collection bin 108 includes a mechanical clasp, the mechanical clasp is also engaged at this step.

After the bin engagement mechanism is engaged with the robot engagement mechanism, the autonomous robot 110 is in the secured position and is configured to collect the waste contained in the full collection bin 108a at step 322. The autonomous robot 110 can lift the full collection bin 108a using a servo motor or other means of lifting the full collection bin 108a. Once the full collection bin 108a is lifted, the autonomous robot 110 will be able to move freely while carrying the full collection bin 108a. In some examples, the autonomous robot 110 collects the waste by carrying the collection bin 108 to the collection facility 114. In other examples, the autonomous robot 110 will collect the waste contained within the collection bin 108 into the robot waste bin 132 and return the empty collection bin 108b to the waste receptacle 102 of the smart bin 100

At step 324, the robot control system 200 determines an emptying path. The emptying path may be included in the collection instruction sent from the bin collection server 112 or the robot control system 200 can determine the emptying path based on the sensed environment, the map of the premises and other information. For example, there may be several bin collection facilities 114 in a premises, and the robot control system 200 can determine the optimal collection facility 114 to navigate to. In some examples, the bin collection server 112 can detect a fill status of the waste containers 116 in the various bin collection facilities 114 and send the fill statuses to the autonomous robots 110. Based on the fill statuses, the robot control system 200 may determine that the nearest or most convenient collection facility 114 is full and thus can determine an emptying path to the next nearest or most conveniently located collection facility 114. In some examples, there can be several collection facilities 114 to include in the emptying path, for example if the autonomous robot 110 is carrying an organic waste collection bin 108 and a paper recycling collection bin 108, there may be two different collection facilities 114 for organic waste and paper recycling, such that the emptying path will include both the collection facilities 114.

The autonomous robot 110 can then navigate to the collection facility 114 at step 326 using the drive system 210. Similar to step 318, the autonomous robot 110 can use the various sensors to monitor its surroundings as the autonomous robot 110 navigates along the emptying path and can update the emptying path based on the sensed surroundings.

Once the autonomous robot 110 arrives at the designated collection facility 114, the autonomous robot 110 can deposit the waste in the collection facility. In some examples, the autonomous robot 110 will deposit the full collection bin(s) 108a in the collection facility 114. The autonomous robot 110 deposits the full collection bin(s) 108a by lowering the prongs 124 while still inserted into the openings 122, and then removing the prongs 124 from the openings 122. Where the collection bin 108 includes a mechanical clasp, the mechanical clasp can remain engaged while the autonomous robot 110 lower the prongs 124, and disengage the mechanical clasp once the prongs 124 have been fully lowered. In other examples, the autonomous robot 110 has a gripping arm 128 that can lower the collection bin 108 in a similar manner to the prongs 124, and then disengage the gripping arm 128 from the collection bin 108 by releasing the gripping force applied by the fingers 130 and moving the fingers 130 away from the collection bin 108. In other examples, the autonomous robot 110 will empty the waste from the robot waste bin 132 into the waste containers 116 in the collection facility 114.

The above discussed embodiments are considered to be illustrative and not restrictive. Example embodiments described as methods would similarly apply to systems, and vice-versa.

The various embodiments presented above are merely examples and are in no way meant to limit the scope of this disclosure. Variations of the innovations described herein will be apparent to persons of ordinary skill in the art, such variations being within the intended scope of the present disclosure. In particular, features from one or more of the above-described embodiments may be selected to create alternative embodiments comprises of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover all suitable changes in technology.

What is claimed is:

1. A system for autonomous waste collection, the system comprising:
a plurality of receptacles, each receptacle having a lid, a fill sensor, and a collection bin, the collection bin having a robot engagement mechanism, the fill sensor being located on an underside of the lid, wherein the fill sensor is configured to detect a fill level of the receptacle;
at least one autonomous robot, the at least one autonomous robot having a plurality of robot sensors and a bin engagement mechanism;
a bin collection server, wherein the bin collection server is separate from the plurality of receptacles and is configured to:
receive a respective fill level from each of the fill sensors;
determine that at least one collection bin has a respective fill level that exceeds a threshold;
generate a collection instruction for the at least one collection bin that exceeds the threshold;
send the collection instruction to the at least one autonomous robot;
wherein the at least one autonomous robot is configured to:
receive the collection instruction from the bin collection server;
navigate, using the plurality of robot sensors, to the at least one collection bin that exceeds the threshold;
engage the bin engagement mechanism with a respective robot engagement mechanism of the collection bin that exceeds the threshold;
collect waste from the collection bin that exceeds the threshold;
navigate, using the plurality of robot sensors, to a collection facility while carrying the waste; and
deposit the waste in the collection facility.

2. The system of claim 1, wherein the autonomous robot is further configured to collect the waste by lifting, using the bin engagement mechanism, the respective collection bin;
carry the respective collection bin while navigating to the collection facility; and
deposit the waste by depositing the respective collection bin in the collection facility.

3. The system of claim 1, wherein the autonomous robot has a robot waste bin, the autonomous robot being further configured to:
collect the waste by lifting, using the bin engagement mechanism, the respective collection bin;
deposit the waste into the robot waste bin;
carry the robot waste bin while navigating to the collection facility; and
deposit the waste by emptying the robot waste bin in a waste container located in the collection facility.

4. The system of claim 1, wherein the bin collection server is further configured to:
identify at least one of a plurality of empty receptacles;
generate a replacement instruction for each of the at least one of the plurality of empty receptacles;
send the replacement instruction to the autonomous robot;
wherein the collection facility has a plurality of empty collection bins;
wherein the autonomous robot is further configured to:
navigate, using the plurality of robot sensors, to the collection facility;
engage the bin engagement mechanism with the robot engagement mechanism of at least one of the plurality of empty collection bins;
lift, using the bin engagement mechanism, the at least one of the plurality of empty collection bins;
navigate, using the plurality of robot sensors, to the at least one of the plurality of empty receptacles; and
insert an empty collection bin into each of the at least one of the plurality of empty receptacles.

5. The system of claim 1, wherein the bin collection server includes a machine learning model.

6. The system of claim 1, wherein the plurality of robot sensors include a proximity sensor, a visual sensor, or an accelerometer.

7. The system of claim 1, wherein the autonomous robot has a scale.

8. The system of claim 7, wherein the autonomous robot is configured to detect a mass of a robot load using the scale.

9. The system of claim 1, wherein the fill sensor is an infra-red distance sensor.

10. The system of claim 1, wherein each fill sensor detects the fill level of the corresponding receptacle by measuring a distance from a top of an interior of the collection bin to a bottom of the interior of the collection bin.

11. The system of claim 1, wherein each of the fill sensors is connected to a power source and is configured to remain disconnected from the power source;
the bin collection server is further configured to:
send a wake up notification to each of the fill sensors; and
each of the fill sensors is further configured to:
receive the wake up notification;
connect to the power source;
detect the fill level of each of the plurality of receptacles; and
send the fill level to the bin collection server.

12. The system of claim 11, wherein the bin collection server is configured to send the wake up notification based on a pre-determined schedule.

13. The system of claim 11, wherein the power source includes a battery; and
the fill sensor is configured to send a battery level to the bin collection server.

14. The system of claim 1 wherein each receptacle has a power source that can provide power to the receptacle and the fill sensor.

15. The system of claim 14, wherein the power source is a solar power source.

16. The system of claim 1, wherein the collection bin includes a top cover that is configured to sealingly engage with the top of the collection bin.

17. The system of claim 1, further comprising a docking station corresponding to the at least one autonomous robot;
the bin collection server being further configured to:
generate a docking instruction;
the autonomous robot being further configured to:
receive, from the bin collection sever, the docking instruction; and
navigate and move, using the plurality of robot sensors, to the docking station.

18. The system of claim 17 wherein the bin collection server is further configured generate the docking instruction after receiving, from the at least one autonomous robot, a power status of the at least one autonomous robot.

19. The system of claim 1, wherein the bin collection server is further configured to convert the fill level to a fill percentage.

20. The system of claim 1, wherein the fill sensor is further configured to detect a temperature of each receptacle.

21. The system of claim 1, wherein the fill sensor is integrated into the lid.

22. The system of claim 1, wherein the fill sensor is an individual component, the fill sensor being configured to attached to the lid.

23. The system of claim 1, wherein the robot engagement mechanism comprises at least one opening in a bottom of an exterior of the collectible bin;
wherein the bin engagement mechanism includes at least one prong connected to a motor, the at least one opening configured to receive the at least one prong; and
wherein when the robot engagement mechanism has received the at least one prong, the motor is configured to lift the collection bin; and wherein the collection bin is configured to move with the autonomous robot when the autonomous robot moves.

24. The system of claim 23, wherein the robot engagement mechanism further comprises a mechanical clasp; and
wherein when the at least one prong is inserted into the at least one opening, the mechanical clasp is configured to grasp the at least one prong.

25. The system of claim 23, wherein the robot engagement mechanism further comprises a magnet; and
wherein when the at least one prong is inserted into the at least one opening, the robot engagement mechanism magnetically connects to the at least one prong.

26. The system of claim 1, wherein the bin engagement mechanism is a gripping arm with at least two fingers; and
wherein the bin engagement mechanism engages the robot engagement mechanism by:
positioning the at least two fingers on opposing sides of the collection bin; and
closing the gripping arm by moving the at least two fingers towards the collection bin.

27. The system of claim 1, wherein the at least one autonomous robot is a humanoid robot;
the bin engagement mechanism includes a robot arm on opposing sides of the humanoid robot;
wherein the bin engagement mechanism engages the robot engagement mechanism by:
positioning the robot arms on opposing sides of the collection bin; and
grasping the collection bin by moving the robot arms towards the collection bin.

28. The system of claim 1, wherein the bin collection server is further configured to receive the fill level of each of the plurality of receptacles at pre-determined intervals.

29. The system of claim 26, wherein the bin collection server is configured to determine the pre-determined intervals using a machine learning model.

30. The system of claim 1, wherein the plurality of receptacles, the at least one autonomous robot, and the collection facility are located on a premises.

31. The system of claim 30, wherein the bin collection server is further configured to:
generate a map of the premises, the map including a location of each of the plurality of receptacles, the fill level of each of the plurality of receptacles, and a location of the at least one autonomous robot;
receive, from the fill sensor and the plurality of robot sensors, a location update for the plurality of receptacles and the autonomous robot;
receive, from each of the fill sensors, a new fill level; and
update the map of the premises based on the location update.

32. The system of claim 31, wherein the bin collection server further comprises a route management module.

33. The system of claim 32, wherein the route management module is configured to:
receive, from the bin collection server, a schedule of staff; and
generate, based on the map of the premises and the schedule of staff, a route plan.

34. The system of claim 32, wherein the route management module is configured to:
receive, from the bin collection server: the location of the at least one autonomous robot, the location of the plurality of receptacles which exceed the threshold, and the collection instruction;
generate, based on the location of the at least one autonomous robot, the location of the plurality of receptacles which exceed the threshold, and the collection instruction, a collection route for the at least one autonomous robot;
the autonomous robot being further configured to:
receive the collection route from the bin collection server; and
navigate and move, using the plurality of robot sensors, along the collection route.

35. The system of claim 31, wherein the route management module is a machine learning model.

36. The system of claim 1, further comprising:
at least one waste container located in the collection facility;
a visual sensor, located in the collection facility;
wherein the visual sensor is configured to:
detect a fill level of the at least one waste container;
the bin collection server being further configured to:
receive, from the visual sensor; the fill level of the at least one waste container; and
determine, based on the fill level of the at least one waste container, a collection status of the at least one waste container.

37. The system of claim 36, wherein the bin collection server is further configured to:
determine, based on the collection status, a waste collection company corresponding to the at least one waste container; and
contact the waste collection company.

38. A method for autonomously managing a waste collection system, the method comprising:
detecting a fill level of each of a plurality of receptacles, using a fill sensor located on an underside of a lid of each of the plurality of receptacles, wherein each of the plurality of receptacles has a collection bin and a robot engagement mechanism;
receiving, by a bin collection server, the fill level of each of a plurality of receptacles;
determining, by the bin collection server, that at least one of the plurality of receptacles has a respective fill level that exceeds a threshold;
identifying, based on the at least one of the plurality of receptacles has a respective fill level that exceeds a threshold, at least one collection bin which exceeds the threshold;
generating, by the bin collection server, a collection instruction for the at least one collection bin which exceeds the threshold;
sending, by the bin collection server, the collection instruction to at least one autonomous robot, wherein the at least one autonomous robot has a plurality of robot sensors, a motor and a bin engagement mechanism;
receiving, by the at least one autonomous robot, the collection instruction from the bin collection server;
determining, by the at least one autonomous robot, a collection path based on the collection instruction;
navigating the at least one autonomous robot along the collection path to the at least one collection bin which exceeds the threshold, using the plurality of robot sensors;
engaging the bin engagement mechanism with a robot engagement mechanism of the at least one collection bin which exceeds the threshold;
collecting waste from the collection bin which exceeds the threshold;
determining, by the at least one autonomous robot, an emptying path based on the collection instruction;
navigating the at least one autonomous robot along the emptying path, to a collection facility, using the plurality of robot sensors; and
depositing the waste in the collection facility.
